(19) United States
(12) Patent Application Publication
(10) Pub. No.: US 2011/0270758 A1
(43) Pub. Date: Nov. 3, 2011

(54) METHOD FOR PROVIDING ELECTRONIC TRANSACTION USING MOBILE PHONES

(76) Inventor: ALI MIZANI OSKUI, TEHRAN (IR)

(21) Appl. No.: 13/179,530

(22) Filed: Jul. 10, 2011

Related U.S. Application Data
(60) Provisional application No. 61/393,234, filed on Oct. 14, 2010.
(60) Provisional application No. 61/371,710, filed on Aug. 8, 2010.

(51) Int. Cl. G06Q 20/00

(52) U.S. Cl. 705/44

(57) ABSTRACT

The embodiments herein provide a method for providing an electronic transaction using the mobile phones. The method comprises dialing one of a Payment Service Provider (PSP) server number by a first mobile user and a second mobile user, arranging the two mobile phones in a head-to-tail fashion, wherein a microphone of the first mobile phone is placed in front of a speaker of the second mobile phones and viceversa, broadcasting a sound signal data by the PSP server to the two mobile phones and transmitting the received sound signal data back to the PSP sever, decoding the sound signal data received from the mobile phones and activating an IVR system. The first mobile phone user enters transaction credentials for an electronic transaction to the second mobile phone user followed by a password through IVR system.

### CROSS-REFERENCE TO RELATED APPLICATIONS

This application claims the benefit of U.S. provisional patent applications Ser. No. 61/393,234, filed 10-14-2010; 61/371,710 filed on Aug. 08, 2010, which are incorporated herein by reference in their entireties.

### BACKGROUND

1. Technical field

The embodiments herein generally relates to a mobile phone application. The embodiments herein particularly relate to performing a secure electronic transaction between a payer and a payee and more particularly relates to electronic transactions involving two mobile phones.

2. Description of the Related Art

Presently different kinds of credit cards and electronic identity cards are issued in the world and are widely used for online transaction purposes. The credit cards and the electronic identity cards are of different kinds such as barcode cards, magnetic cards, contact and contactless cards with chip and the like. Various enterprises such as insurance companies and banks, time and attendance companies, telecommunication companies (telephone cards), bus and metro companies (electronic tickets) issues the electronic identity cards for identification and execution of the financial operations between a customer and the companies. However the electronic cards and credit cards come with various defects such as variety of the cards cause confusion among the customers. Also carrying multiple cards becomes tedious and further the customer may forget to carry multiple cards all the time.

The currently existing cards especially the banking magnetic cards often used by the customers involve low security. Further, the usage of cards require either one of electronic terminals or banking POS (Point Of Sale) which are absent at certain locations. Moreover, production and issuance of the cards are expensive and issuance of the credit card requires the customers to open a bank account accordingly. Furthermore payments of bus fare, metro fare and taxi fare using the conventional credit cards becomes difficult considering the time consumption involved in payment process. Also a single credit card fails to serve purpose of its usage all across the globe.

Yet in another scheme NFC (Near Field Communication) technology has entered into the world of mobile phones. The mobile phone manufacturing companies use NFC on few of their products which included contactless cards in the mobile phone. Further, different applications such as credit cards and electronic identification cards were created for the mobile phone. However the mobile phones failed to gain market recognition due to high expense of NFC. Moreover, many mobile producing companies failed to include NFC technology in their mobile phones. Furthermore in the mere future due to economical and security reasons various customers prefer using simple phones which even does not have the technology of Bluetooth.

In light of foregoing discussion there exists a need to provide a method for online transaction between a payer and a payee using two mobile phones. Also there exists a need to provide a transaction between two mobile phone users which does not require a dedicated hardware/software component in the users' mobile terminals. Further, there exists a need to convert the mobile phone into one of an electronic identification card or a credit card for online mobile transactions across globe.

The abovementioned shortcomings, disadvantages and problems are addressed herein and which will be understood by reading and studying the following specification.

### OBJECTS OF THE EMBODIMENTS

The primary object of the embodiments herein is to provide a method for electronic transaction between a payer and a payee using mobile phones with a Near Sound Communication (NSC) technique.

Another object of the embodiments herein is to provide a method for electronic transaction between two mobile users through one of a Payment Service Provider (PSP) and an Ummoney centre using NSC technique.

Yet another object of the embodiments herein is to provide electronic transaction using NSC technique between two mobile users by dialing Interactive Voice Response (IVR) number of one of a Payment Service Provider (PSP) and an Ummoney centre.

Yet another object of the embodiments herein is to provide transaction between two mobile phones placed in a head-to-tail fashion using Near Sound Communication (NSC) technique.

Yet another object of the embodiments herein is to provide transaction between two mobile phones without need for a dedicated hardware/card reader/software component in the mobile phones.

Yet another object of the embodiments herein is to convert the mobile phone into one of an electronic identification card/credit card for online mobile transactions across globe.

Yet another object of the embodiments herein is to provide data transaction between one mobile user and another mobile user using NSC technique.

Yet another object of the embodiments herein is to provide transaction between two mobile phones independent of mobile network operators and banking service providers associated with mobile phone users.

### SUMMARY

These and other objects and advantages of the present disclosure will become readily apparent from the following detailed description taken in conjunction with the accompanying drawings.

The various embodiments herein provide a The various embodiments herein provide a method for providing electronic transaction using mobile phones using a Near Sound Communication technique. The method comprising dialing one of a Payment Service Provider (PSP) server number by a first mobile phone user and a second mobile phone user, wherein a first mobile phone is associated with the first mobile phone user and a second mobile phone is associated with a second mobile phone user, arranging the first mobile phone and the second mobile phone in a head-to-tail manner, wherein one of a microphone of the two mobile phones is placed in front of one of a loudspeaker of the two mobile phones. The method further comprising broadcasting a sound signal data by the PSP server to the first mobile phone and the second mobile phone, receiving a sound signal data by one of microphones of the two mobile phones and transmitting the received sound signal data to the PSP sever by one of the microphones of the two mobile phones. The first mobile phone user enters one of a data and an amount to be transferred to the second mobile phone user followed by a password in the first mobile phone through an Interactive Voice Response (IVR) system for online transaction between the first mobile phone user and the second mobile phone user.

According to an embodiment of the present disclosure, the first mobile phone user and a second mobile phone user dials at least one of Payment Service Provider (PSP) server and an Ummoney centre server number for electronic transaction.

According to an embodiment of the present disclosure, dialling provides for connecting the first mobile phone and the second mobile phone with the PSP server.

According to an embodiment of the present disclosure, transmitting the received sound signal comprises sending a first sound signal data to the first mobile phone, wherein the first sound signal data is received by microphone of the first mobile phone and sending a second sound signal data to the second mobile phone; wherein the second sound signal data is received by microphone of the second mobile phone.

According to an embodiment of the present disclosure, transmitting the received sound signal further comprises transmitting the received first sound signal data from speaker of first mobile phone to microphone of the second mobile phone, receiving the transmitted first sound signal data by the PSP server, transmitting the received second sound signal data from speaker of second mobile phone to microphone of the first mobile phone and receiving the transmitted second sound signal data through a receiver at the PSP server. Transmitting the received sound signal further comprising decoding the received first sound signal data and the second sound signal data in the PSP server, identifying mobile phone numbers of the first mobile phone and the second mobile phone in the PSP server, cutting the first sound signal data and the second sound signal data by the PSP server and activating an IVR system in the PSP Server.

According to an embodiment of the present disclosure, activating the IVR system comprises reporting one of a successful transaction and an unsuccessful transaction to the first mobile phone and the second mobile phone and terminating connection of the first mobile phone and the second mobile phone with the PSP server.

According to an embodiment of the present disclosure, broadcasting the sound signal data comprising authenticating the MSISDN number of the first mobile phone and the second mobile phone and activating the IVR system on the first mobile phone and the second mobile phone.

According to an embodiment of the present disclosure, the sound signal data comprises MSISDN numbers of the first mobile phone and the second mobile phone and server details in an encrypted form.

According to an embodiment of the present disclosure, the electronic transaction is performed for at least one of a data transfer and financial transaction.

The various embodiments herein provide a method for electronic transaction between a payer and a payee using two mobile phones and Near Sound Communication (NSC) technique. The transaction between two mobile phones is independent of mobile network operators and banking service providers associated with mobile phone users. In addition to the financial transaction, the method also provides for data transaction between two mobile phone users. Further, the method provides transaction between two mobile phones without need for a separate dedicated hardware, card reader, or additional software in the mobile phones. Also the method converts the mobile phone into one of an electronic identification card or a credit card for online mobile transactions across globe.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a system diagram illustrating electronic transaction between two mobile phones according to an embodiment of the present disclosure.

FIG. 2 is a flow chart illustrating electronic transaction between two mobile phones according to an embodiment of the present disclosure.

Although the specific features of the present invention are shown in some drawings and not in others. This is done for convenience only as each feature may be combined with any or all of the other features in accordance with the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for providing electronic transaction using mobile phones using a Near Sound Communication technique. The method comprising dialing a Payment Service Provider (PSP) server number by a first mobile phone user and a second mobile phone user, wherein the first mobile phone is associated with the first mobile phone user and a second mobile phone is associated with the second mobile phone user, arranging the first mobile phone and the second mobile phone in a head-to-tail manner, wherein one of a microphone of the two mobile phones is placed in front of one of a loudspeaker of the two mobile phones. The method further comprising broadcasting a sound signal data by the PSP server to the first mobile phone and the second mobile phone, receiving a sound signal data by one of microphones of the two mobile phones and transmitting the received sound signal data back to the PSP sever by one of the microphones of the two mobile phones. The first mobile phone user enters one of a data and an amount to be transferred to the second mobile phone user followed by a password in the first mobile phone through an Interactive Voice Response (IVR) system for online transaction between the first mobile phone user and the second mobile phone user.

According to an embodiment of the present disclosure, dialing provides for connecting the first mobile phone and the second mobile phone to the PSP server.

According to an embodiment of the present disclosure, transmitting the received sound signal comprises sending a first sound signal data to the first mobile phone, wherein the first sound signal data is received by microphone of the first mobile phone and sending a second sound signal data to the second mobile phone; wherein the second sound signal data is received by microphone of the second mobile phone.

According to an embodiment of the present disclosure, transmitting the received sound signal further comprises transmitting the received first sound signal data from speaker of first mobile phone to microphone of the second mobile phone, receiving the transmitted first sound signal data by the PSP server, transmitting the received second sound signal data from speaker of second mobile phone to microphone of the first mobile phone and receiving the transmitted second sound signal data by the PSP server. Transmitting the received sound signal further comprising decoding the received first sound signal data and the second sound signal data by the PSP server, identifying mobile phone numbers of the first mobile phone and the second mobile phone by the PSP server, cutting the first sound signal data and the second sound signal data by the PSP server and activating the IVR system.

According to an embodiment of the present disclosure, activating the IVR system comprises reporting one of a successful transaction and an unsuccessful transaction to the first mobile phone and the second mobile phone and terminating connection of the first mobile phone and the second mobile phone with the PSP server.

According to an embodiment of the present disclosure, broadcasting the sound signal data comprising authenticating the MSISDN number of the first mobile phone and the second mobile phone and activating the IVR system on the first mobile phone and the second mobile phone.

According to an embodiment of the present disclosure, the sound signal data comprises MSISDN numbers of the first mobile phone and the second mobile phone and server details in an encrypted form.

According to an embodiment of the present disclosure, the electronic transaction is performed for at least one of a data transfer and financial transaction.

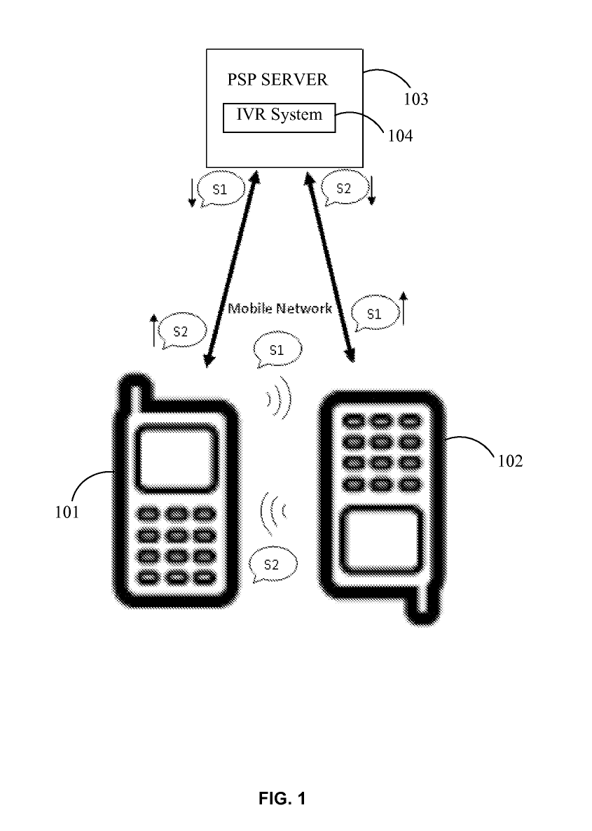

FIG. 1 is a system diagram illustrating an electronic transaction between two mobile phones according to an embodiment of the present disclosure. The system arrangement comprises of a first mobile phone 101 and a second mobile phone 102 arranged in a head-to-tail manner and a PSP server 102 in communication with the first mobile phone 101 and a second mobile phone 102. The first mobile phone 101 and a second mobile phone 102 are arranged such that one of the microphones of at least one mobile phone is located in front of one of the speakers of at least one mobile phone. The first mobile phone 101 user and the second mobile phone 102 dial the PSP server IVR number to establish connection with the PSP server 103.

Once the connection is established, the PSP server 103 sends sound signal data to the first mobile phone 101 and the second mobile phone 102. Here, the PSP server 103 sends a first sound signal data Si to the first mobile phone 101 which is broadcasted from speaker of first mobile phone 101 through the microphone of the second mobile phone 102 and is transmitted back to the PSP server 103. Simultaneously, the IVR server 103 sends a second sound signal data S2 to the second mobile phone 102 which is broadcasted from speaker of the second mobile phone 102 through the microphone of the first mobile phone 101 which is transmitted back to the PSP server 103. The first sound signal data S1 include the MSISDN number of the first mobile phone 101 along with the server details in an encrypted form and the second sound signal data S2 include the MSISDN number of the second mobile phone 102 along with the server details in an encrypted form.

On receiving the first sound signal data S1 and the second sound signal data S2, the PSP server decodes the received first sound signal data S1 and the second sound signal data S2 to identify the server details and the mobile phone numbers of the first mobile phone 101 and the second mobile phone 102. The PSP server 103 then cut the first sound signal data S1 and the second sound signal data S2 and activates an IVR system 104 present in the PSP server 103.

In an embodiment herein, once the connection is established, the first mobile phone 101 user and the second mobile phone 102 user provides request through IVR orders. The payer enters the amount and the password through the IVR system 104. The IVR system further reports one of a successful transaction and an unsuccessful transaction to the first mobile phone 101 and the second mobile phone 102. Upon completion of the transaction, the IVR system 104 terminates connection of the first mobile phone 101 and the second mobile phone 102 with the PSP server 103. According to the embodiments herein, the payer and payee is at least one of a first mobile phone user 101 and the second mobile phone user 102.

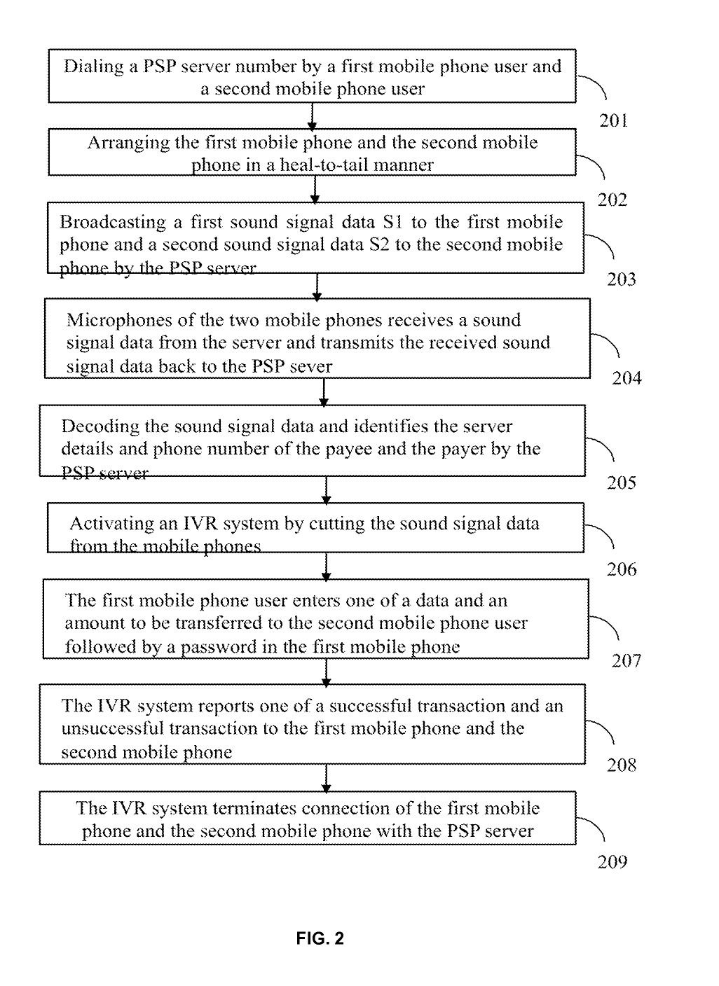

FIG. 2 is a flow chart illustrating electronic transaction between two mobile phones according to an embodiment of the present disclosure. The embodiments herein provide a method for providing electronic transaction using mobile phones using a Near Sound Communication technique. At step 201, a first mobile phone user and a second mobile user dials a Payment Service Provider (PSP) server number. At step 202, the first mobile phone and the second mobile phone is arranged in a head-to-tail manner, wherein one of a microphone of the two mobile phones is placed in front of one of a speaker of the two mobile phones. At step 203, the PSP server broadcast a first sound signal data S1 to the first mobile phone and a second sound signal data S2 to the second mobile phone. At step 204, one of microphones of the two mobile phones receives a sound signal data from the server and transmits the received sound signal data back to the PSP sever through one of the microphones of the two mobile phones. At step 205, the PSP decodes the sound signal data and identifies the server details and phone number of the payee and the payer. At step 206, the PSP server activates an IVR system by cutting the sound signal data from the mobile phones. At step 207, the first mobile phone user enters one of a data and an amount to be transferred to the second mobile phone user followed by a password in the first mobile phone through an Interactive Voice Response (IVR) system for online transaction between the first mobile phone user and the second mobile phone user. At step 208, the IVR system reports one of a successful transaction and an unsuccessful transaction to the first mobile phone and the second mobile phone. At step 209, the IVR system terminates connection of the first mobile phone and the second mobile phone with the PSP server.

The various embodiments herein provide a method for electronic transaction between a payer and a payee using two mobile phones and Near Sound Communication (NSC) technique. The transaction between two mobile phones is independent of mobile network operators and banks associated with mobile phone users. Apart from financial transaction the method also provides data transaction between two mobile phone users. Further, the method provides transaction between two mobile phones without the need for a separate dedicated hardware, card reader, or additional software in the mobile phones. Also the method converts the mobile phone into one of an electronic identification card or a credit card for online mobile transactions across globe.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for providing electronic transaction using mobile phones, the method comprises a steps of:
dialing a Payment Service Provider (PSP) server number by a first mobile phone user and a second mobile phone user, wherein a first mobile phone is associated with the first mobile phone user and a second mobile phone is associated with the second mobile user;
arranging the first mobile phone and the second mobile phone in a head-to-tail manner, wherein a microphone of the first mobile phone is placed in front of a speaker of the second mobile phone and viceversa;
broadcasting a sound signal data by the PSP server to the first mobile phone and the second mobile phone;
receiving a sound signal data by one of microphones of the first mobile phone and the second mobile phone; and
transmitting the received sound signal data back to the PSP server through one of the microphones of the first mobile phone and the second mobile phone;
decoding the received sound signal data by the PSP server;
identifying a mobile phone number of the first mobile phone and the second mobile phone by the PSP server;
cutting the sound signal data by the PSP server; and
activating the IVR system;
wherein the first mobile phone user enters one of a data and an amount to be transferred to the second mobile phone user along with a password in the first mobile phone through an Interactive Voice Response (IVR) system for an online electronic transaction between the first mobile phone user and the second mobile phone user.

2. The method of claim 1, wherein the PSP server is an Ummoney centre server.

3. The method of claim 1, wherein the step of dialing comprises connecting the first mobile phone and the second mobile phone to the PSP server.

4. The method of claim 1, wherein the step of transmitting further comprises:
sending a first sound signal data to the first mobile phone, wherein the first sound signal data is received by microphone of the first mobile phone; and
sending a second sound signal data to the second mobile phone; wherein the second sound signal data is received by microphone of the second mobile phone.

5. The method of claim 1, wherein the step of transmitting the received sound signal further comprises:
transmitting the received first sound signal data from a speaker of the first mobile phone to a microphone of the second mobile phone;
receiving the transmitted first sound signal data by the PSP server;
transmitting the received second sound signal data from a speaker of the second mobile phone to a microphone of the first mobile phone; and
receiving the transmitted second sound signal data by the PSP server.

6. The method of claim 1, wherein activating the IVR system comprises:
reporting one of a successful transaction and an unsuccessful transaction to the first mobile phone and the second mobile phone; and
terminating connection of the first mobile phone and the second mobile phone with the PSP server.

7. The method of claim 1, wherein broadcasting the sound signal data comprising:
authenticating the MSISDN number of the first mobile phone and the second mobile phone; and
activating the IVR system on the first mobile phone and the second mobile phone.

8. The method of claim 1, wherein the first sound signal data comprising MSISDN number of the first mobile phone and the PSP server details in an encrypted form.

9. The method of claim 1, wherein the second sound signal data comprising MSISDN number of the second mobile phone and the PSP server details in an encrypted form.

10. The method of claim 1, wherein the electronic transaction is performed for at least one of a data transfer and financial transaction.
